(19) United States
(12) Patent Application Publication
(10) Pub. No.: US 2025/0233886 A1
(43) Pub. Date: Jul. 17, 2025

(54) METHOD FOR CONFIGURING A HONEYPOT

(71) Applicant: Robert Bosch GmbH, Stuttgart (DE)

(72) Inventors: Christopher Huth, Heilbronn (DE); Dominik Germek, Berlin (DE); Niclas Ilg, Ammerbuch (DE)

(21) Appl. No.: 19/015,125

(22) Filed: Jan. 9, 2025

(30) Foreign Application Priority Data
Jan. 12, 2024 (EP) 24 15 1625.1

(51) Int. Cl. H04L 9/40; G06F 40/30

(52) U.S. Cl. CPC H04L 63/1491; G06F 40/30; H04L 63/1416

(57) ABSTRACT

A method for configuring a honeypot. The method includes: implementing a honeypot, conducting at least one attack on the honeypot by means of a large language model, ascertaining an assessment of the at least one attack; and configuring the honeypot depending on the assessment of the at least one attack.

### FIELD

The present invention relates to a method for configuring a honeypot.

### BACKGROUND INFORMATION

The number of networked data processing devices (including embedded devices) is increasing rapidly. An important aspect of all these devices, be they server computers on the Internet or control devices in the automotive or IoT sector, is product security. Honeypots are dummies that imitate such a valuable (target) system in order to attract attackers and gain information about their attack strategies and targets. Honeypots are an established tool for threat analysis, especially in corporate IT, and they are now also used in the area of the (industrial) Internet of Things ((I) IoT).

In order to effectively fulfill this purpose, honeypots must arouse the interest of attackers and maintain it for as long as possible, i.e., in particular, they must be credible and simulate or suggest vulnerabilities so that an attacker interacts with a particular honeypot as much as possible.

Approaches for ascertaining configurations for effective honeypots are therefore desirable.

### SUMMARY

According to various example embodiments of the present invention, a method for configuring a honeypot is provided, comprising implementing a honeypot, conducting at least one attack on the honeypot by means of a large language model, ascertaining an assessment of the at least one attack; and configuring the honeypot depending on the assessment of the at least one attack.

Configuring can mean retaining or changing the configuration used to implement the honeypot. For example, the assessment is retained if it is above a specified minimum (threshold value), i.e., if it meets a specified quality criterion. The configuration can be carried out automatically (e.g., a plurality of configurations is tested automatically) and the best one (the one with the highest assessment(s) of one or more attacks) can be selected.

The method of the present invention described above makes it possible to assess the quality of an interactive honeypot automatically, regardless of the target system that the honeypot imitates, and to ascertain, on the basis of the assessments for different configurations of the honeypot, the configuration for the honeypot so that the honeypot effectively fulfills its purpose.

Various exemplary embodiments of the present invention are specified below.

Exemplary embodiment 1 is a method for configuring a honeypot, as described above.

Exemplary embodiment 2 is a method according to exemplary embodiment 1, wherein, for ascertaining the assessment of the at least one attack, an assessment with regard to the number of interactions of the large language model with the honeypot takes place.

For example, the more interactions take place, the higher the at least one attack is assessed. In an actual attack, the number of interactions an attacker performs can be seen as a measure of their interest in the honeypot. By using corresponding assessments, it is therefore possible to generate interesting honeypots. Ascertaining the assessment may include averaging over a plurality of attacks: For example, if fifty interactions take place in each of two attacks and only ten interactions take place in one attack, this can still result in a good assessment. For example, each attack corresponds to the pursuit of a particular vulnerability (i.e., the attempt to exploit a specific corresponding vulnerability).

Exemplary embodiment 3 is a method according to exemplary embodiment 1 or 2, wherein configuring the honeypot depending on the assessment of the at least one attack comprises ascertaining whether the assessment of the at least one attack is above a specified threshold value and, in response to the assessment of the at least one attack not being above the specified threshold value, changing the behavior of the honeypot to a state in which the honeypot was when the large language model no longer made progress on the attack.

The configuration of the honeypot may thus be adapted in such a way that attacks that are not of sufficient interest (for example, those that the LLM aborted after a few interactions) are made more interesting by changing the behavior of the honeypot to a state at the end of a previous attack attempt.

Exemplary embodiment 4 is a method according to one of exemplary embodiments 1 to 3, wherein conducting the at least one attack on the honeypot comprises generating, by the large language model, at least one input for a command line interface that the honeypot simulates, and feeding the at least one generated input into the simulated command line interface.

Command line interfaces expect inputs in text form. These inputs can be generated effectively and with the correct syntax by a large language model. A response of the command line interface can then be fed back into the large language model (as a prompt) so that the large language model can generate a new input.

Exemplary embodiment 5 is a method according to one of exemplary embodiments 1 to 4, comprising training or retraining the large language model on the basis of examples (e.g., short programs such as scripts) of exploiting known vulnerabilities.

This makes it possible to increase the performance of the large language model in terms of correct inputs for the honeypot and thus to obtain assessments that better correspond to reality.

Exemplary embodiment 6 is a method according to one of exemplary embodiments 1 to 5, comprising implementing the honeypot for each of a plurality of configurations, conducting, for each configuration, at least one attack on the honeypot by means of a large language model, and ascertaining an assessment of the at least one attack for each configuration. Selecting a configuration of the honeypot from the plurality of configurations that provides the best assessment, and configuring the honeypot according to the selected configuration.

A plurality of configurations can thus be tested, which can also be created from one another through random changes (mutations). Generating configurations, testing, and ultimately selecting the best configuration (e.g., the one that provides the highest average assessment, e.g., the highest number of interactions, for a specified set of attacks) can be carried out automatically.

Exemplary embodiment 7 is a honeypot configuration device configured to carry out a method according to one of exemplary embodiments 1 to 6.

Exemplary embodiment 8 is a computer program comprising commands which, when executed by a processor, cause the processor to carry out a method according to one of exemplary embodiments 1 to 6.

Exemplary embodiment 9 is a computer-readable medium storing commands which, when executed by a processor, cause the processor to carry out a method according to one of exemplary embodiments 1 to 6.

In the figures, similar reference signs generally refer to the same parts throughout the various views. The figures are not necessarily true to scale, with emphasis instead generally being placed on the representation of the principles of the present invention. In the following description, various aspects of the present invention are described with reference to the figures.

### BRIEF DESCRIPTION OF THE DRAWINGS

FIG. 1 shows a computer network, according to an example embodiment of the present invention.

FIG. 2 illustrates ascertaining the configuration of a honeypot according to one example embodiment of the present invention.

FIG. 3 shows a flowchart, which represents a method for configuring a honeypot according to one example embodiment of the present invention.

### DETAILED DESCRIPTION OF EXAMPLE EMBODIMENTS

The following detailed description relates to the accompanying drawings, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

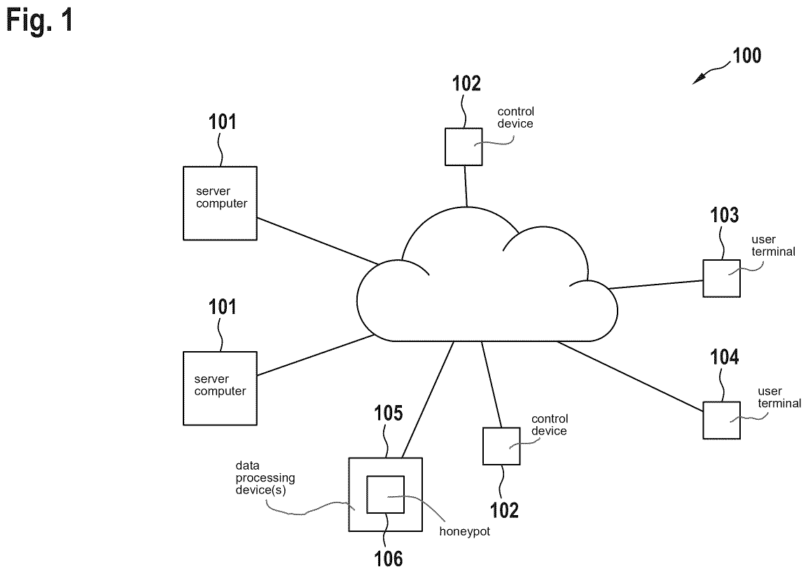

FIG. 1 shows a computer network 100. The computer network 100 contains a plurality of data processing devices 101-105 interconnected by communication links. The data processing devices 101-105 include, e.g., server computers 101 and control devices 102 along with user terminals 103, 104.

Server computers 101 provide various services, such as Internet sites, banking portals, etc. A control device 102 is, e.g., a control device for a robot device, such as a control device in an autonomous vehicle. The server computers 101 and control devices 102 thus fulfill different tasks and typically a server computer 101 or a control device 102 can be accessed from a user terminal 103, 104. This is particularly the case if a server computer 101 offers a functionality to a user, such as a banking portal. However, a control device 102 can also allow access from outside (e.g., so that it can be configured). Depending on the task of a server computer 101 or control device 102, they can store security-related data and execute security-related tasks.

Accordingly, they must be protected against attackers. For example, an attacker using one of the user terminals 104 could, through a successful attack, gain possession of confidential data (such as keys), manipulate accounts or even manipulate a control device 102 in such a way that an accident occurs.

A security measure against such attacks is a so-called honeypot 106 (which is implemented by one of the data processing devices 105). It seemingly provides a functionality and thus serves as bait to attract potential attackers. However, it is isolated from confidential information or critical functionality so that attacks on it take place in a controlled environment and the risk of compromising the actual functionality is minimized. It thus makes it possible to gain knowledge about attacks on a target system (e.g., one of the server computers 101 or one of the control devices 102), and thus the threat landscape, to which the implementation of suitable measures on the target system can respond, without these attacks endangering the target system.

Especially for the automotive industry, honeypots are of interest since there are hardly any data on actual attacks. According to various embodiments, the honeypot 106 can thus, for example, be implemented in a vehicle. The computer network 100 can then at least partially include an internal network of the vehicle (but also a network that establishes connectivity to the vehicle from the outside, such as a mobile radio network).

A honeypot is thus a deception system that imitates a target system (also referred to as a “valuable target”). It entices attackers to attack the honeypot and expose attack vectors that target the actual, valuable target. For example, a web server (or the web server software) is a popular option that is imitated by a honeypot. Since web servers make up a large portion of the public Internet, it is important to continuously monitor for threats targeting them. In other words, honeypots are decoy resources that imitate a valuable target system in order to attract attackers. Honeypots are used in order to be attacked, so that the defenders that closely monitor the systems gain insights about the strategies of the opponent. The value of these insights depends on the number of interaction possibilities that the honeypot offers to the attacker.

Honeypots with average interaction are computer programs that simulate internal features of their target system. They may inter alia include a system shell, a file system, and internal services. The functionalities of the operating system (OS) are typically manually (re-)implemented so that they correspond to the functionality of the target system. However, not only is this approach prone to errors, but most honeypot developers implement, for example, only a subset of the system shell commands that they expect attackers to use. Currently, there is no tool that can automatically check whether the operating system functionalities are implemented without errors and whether the implemented functionalities cover a sufficient portion of the operating system to be interesting and credible to attackers.

Honeypots can be formally analyzed by means of so-called CPNs (colored Petri nets). In this case, the honeypot is represented in the form of states and transitions, similarly to a state machine, in order to map potential attacker paths. This is used to analyze where the honeypot has dead ends and how an attacker can move within a system. Although a developer could compare a CPN of a honeypot with the corresponding target system, the developer must implement the entire target system in the honeypot for this purpose in order to obtain a honeypot with a CPN matching the target system. In practice, however, a honeypot should not execute any commands that can be used to harm third parties or the system itself, but should only generate shell outputs indicating successful execution. In addition, a CPN does not reveal any errors in the implementation of the particular functionalities (e.g., typos), and the behavior of an attacker is not included in the analysis by default, but must be identified and inserted manually.

However, in order to provide an effective honeypot, it is important to ensure that a honeypot imitates the corresponding target system in a credible (and sufficiently complete) manner for attackers and also offers vulnerabilities (but only simulates them, i.e., the honeypot should not actually pose a security risk) so that an attacker spends as much time as possible with the honeypot (i.e., interacts with the honeypot as much as possible) so that as much as possible can be learned about the behavior of the attacker.

According to various embodiments, a large language model (LLM), i.e., an (automated) large language model, is used to simulate an attacker attacking a honeypot. On the basis of the interactions between the LLM and the honeypot, it can then be assessed how well the honeypot imitates the corresponding target system in a manner that is credible and interesting to attackers, and, on the basis of the assessment, the quality of the honeypot can again be improved in this respect.

This makes it possible to assess the quality of the simulation of a target system by a honeypot automatically. This automatic assessment can be integrated into automatic honeypot development or configuration processes. The automatic assessment of a honeypot is independent of (e.g.) the operating system that the honeypot imitates. The assessment is based on likely attacker behavior (as represented by the LLM). For example, the configuration of the honeypot can be adapted to the probability that a particular function will be used in attacks. For example, the assessment takes into account not only the existence but also the quality of the functionalities of the target system implemented by the honeypot. The assessment is based on the perspective of the attacker in order to assess security measures that an attacker should not discover, and thus follows a black box approach.

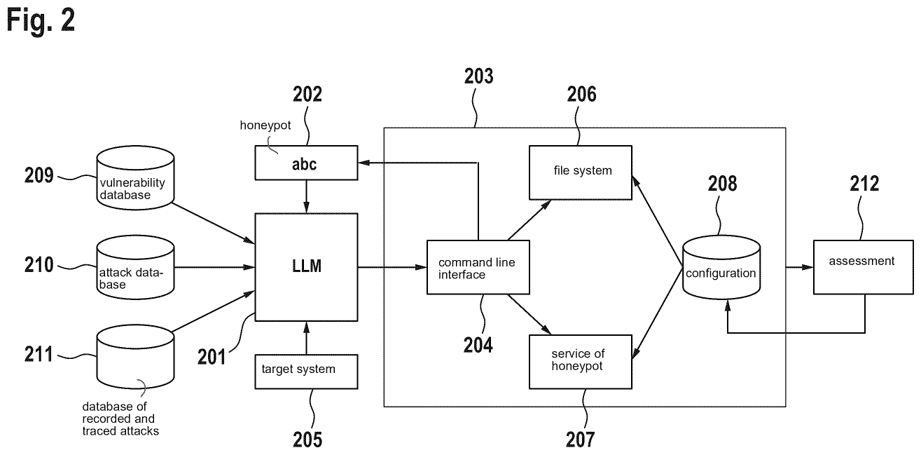

FIG. 2 illustrates ascertaining the configuration 208 of a honeypot 202 according to one embodiment.

A configuration for the honeypot is ascertained by a honeypot generation device (or honeypot configuration device), which corresponds, for example, to one of the user terminals 104 (e.g., a computer with which a user (such as a system administrator) configures the honeypot 106 and instructs the data processing device 105 to provide the honeypot 106 thus configured). The methods described herein for generating a honeypot are thus carried out, for example, by such a honeypot generation device (for example automatically).

An LLM 201 (e.g., implemented by the honeypot generation device) is prompted by means of a corresponding prompt 202 to conduct an attack on a honeypot 203 (which can be implemented by the honeypot generation device or another data processing device for the duration of the configuration). The honeypot 203 implements (or simulates) a command line interface (e.g., a system shell) 204 of a target system 205, a file system 206 of the target system 205, and services 207 of the target system 205 according to its configuration 208. The simulated command line interface 204 can access the file system 206 and the services 207 of the honeypot 202.

The attack by the LLM 201 now consists, for example, in the LLM 201 outputting commands for the command line interface 204, these commands being fed into the command line interface 204 (e.g., the LLM 201 can be connected to the honeypot 203 accordingly), and the responses of the command line interface 204 being in turn fed into the LLM 201 (which is prompted by the original prompt 202 or by further prompts 202, with which the responses are fed into the LLM 201, to continue with the attack as far as possible).

If a pre-built LLM (from a third party) is used, it may have a filter that prevents it from generating attacks. However, there are ways to bypass these filters. Alternatively, an LLM can be trained specifically to generate attacks on honeypots, or at least a base model can be retrained to conduct attacks.

The training of the LLM 201 (or possibly the generation of the prompts 202) includes, for example, information from the following components:
Vulnerability database 209: Information about vulnerabilities can be in the form of a CVE database, i.e., it contains known vulnerabilities. Attackers often refer to CVEs in order to see if a system still contains vulnerable software, i.e., an unpatched version, in order to exploit known bugs.
Attack database 210: While the vulnerability database 209 helps to find out which vulnerabilities might still be present in the particular software, this information alone is not sufficient to exploit the vulnerabilities. This purpose requires some kind of program, such as a script. The attack database 210 contains examples of scripts used to exploit common vulnerabilities in an automated manner (i.e., examples of the exploitation of known vulnerabilities).
Database of recorded and traced attacks 211: This database stores logs and traces of actual attacks, which logs and traces are used by the LLM 201 to repeat (i.e., reenact) these attacks against honeypots.
Critical example system 205: One or more examples of the target system 205 can be used to train the LLM 201. This ensures that certain exploits are known to the LLM 201 and can be exploited by the LLM 201.

The LLM 201 can be trained, for example, by means of reinforcement learning (e.g., RLHF (reinforcement learning with human feedback)), i.e., people can assess whether it conducts suitable attacks on a corresponding example target system 205.

The configuration 208 of the honeypot 202 (which includes the configuration of the file system 206 and of the services) is stored according to one embodiment in a separate memory that is not accessible from the command line interface 204. This configuration 208 is adapted (i.e., ideally optimized) on the basis of the course of the interaction between the LLM 201 and the honeypot 202 (specifically with the command line interface 204).

For this purpose, during the simulated attack (i.e., the attack conducted by the LLM 201), it is observed how the LLM 201 and the honeypot 202 and in particular how the honeypot 202 behaves, i.e., how the interaction depends on the behavior of the honeypot 202. This is used to calculate an assessment 212, which indicates (or estimates) how interesting the honeypot 202 (according to its current configuration 208) would be to an attacker. Particularly interesting, for example, are vulnerable versions of services 207 and those where an attacker requires extensive communication to trigger a corresponding vulnerability. Accordingly, the number of interactions that the LLM 201 undertakes for an attack attempt can, for example, be included in the assessment. On the basis of this assessment, the configuration 208 is changed if necessary (e.g., a plurality of configurations is tested, possibly randomly by means of “mutations,” in order to ascertain whether the honeypot 202 can become more interesting through such a change, and the best configuration 208 thus ascertained is selected).

For example, the honeypot configuration device performs the following:
1. Optionally, a specific LLM can be trained or a base model can be retrained to have no attack filter. Otherwise, the filter of a given LLM 201 is bypassed.
2. A prompt 202 is generated in order to instruct the LLM 201 to attack the honeypot 202.
3. The output generated by the LLM 201 (in response to the prompt 202) is forwarded to the command line interface 204 of the honeypot 202 and, if applicable, the response of the command line interface 204 is returned in a further prompt 202 to the LLM 201. In parallel thereto, the assessment 212 is ascertained.
4. Step 3 is repeated, e.g., until the ascertained assessment no longer increases (e.g., because the LLM 201 no longer meaningfully pursues the attack(s)) or after a certain period of time or number of command line interface inputs.

The above can be performed for multiple prompts and configurations 208 of the honeypot in order to find the configuration 208 that provides the best assessments for different prompts and/or attacks. This configuration can then be selected.

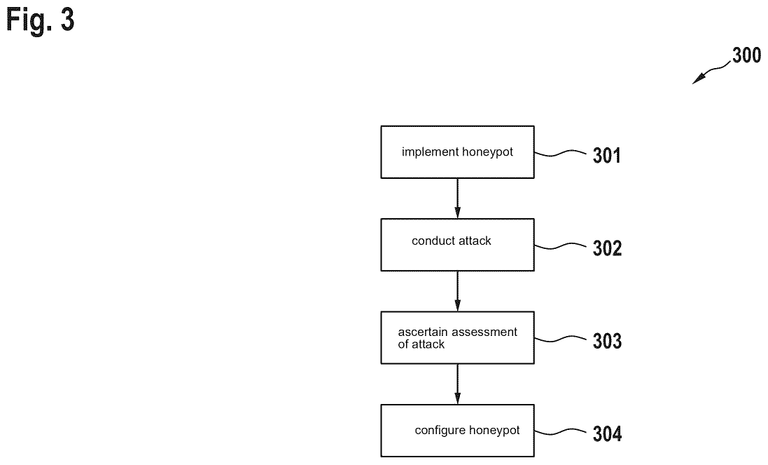

In summary, according to various embodiments, a method is provided as shown in FIG. 3.

FIG. 3 shows a flowchart 300, which represents a method for configuring a honeypot according to one embodiment.

In 301, a honeypot is implemented.

In 302, at least one attack on the honeypot is conducted by means of a large language model.

In 303, an assessment of the at least one attack is ascertained.

In 304, the honeypot is configured depending on the assessment of at least one attack.

In other words, according to various embodiments, an LLM is used to attack a honeypot in order to check its quality and, on the basis of the result of the check, to change its configuration, if necessary, in order to increase its quality.

The method of FIG. 3 can be performed by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the particular functions described in more detail herein may also be understood as a data processing unit or logic circuit assembly. One or more of the method steps described in detail here can be executed (e.g. implemented) by a data processing unit by means of one or more special functions that are performed by the data processing unit.

The method is therefore in particular computer-implemented according to various embodiments.

1-9. (canceled)

10. A method for configuring a honeypot, comprising the following steps:
implementing a honeypot;
conducting at least one attack on the honeypot using a large language model;
ascertaining an assessment of the at least one attack; and
configuring the honeypot depending on the assessment of the at least one attack.

11. The method according to claim 10, wherein, for ascertaining the assessment of the at least one attack, an assessment with regard to a number of interactions of the large language model with the honeypot takes place.

12. The method according to claim 10, wherein the configuring of the honeypot depending on the assessment of the at least one attack includes ascertaining whether the assessment of the at least one attack is above a specified threshold value and, in response to the assessment of the at least one attack not being above the specified threshold value, changing a behavior of the honeypot to a state in which the honeypot was when the large language model no longer made progress on the attack.

13. The method according to claim 10, wherein the conducting the at least one attack on the honeypot includes generating, by the large language model, at least one input for a command line interface that the honeypot simulates, and feeding the at least one generated input into the simulated command line interface.

14. The method according to claim 10, further comprising training or retraining the large language model based on examples of exploiting known vulnerabilities.

15. The method according to claim 10, further comprising:
implementing the honeypot for each of a plurality of configurations;
conducting, for each configuration, at least one attack on the honeypot using the large language model;
ascertaining an assessment of the at least one attack for each configuration;
selecting a configuration of the honeypot from the plurality of configurations that provides a best assessment relative of assessments of the others of the plurality of configurations; and
configuring the honeypot according to the selected configuration.

16. A honeypot configuration device configured to configure a honeypot, the honeypot configuration device configured to:
implement a honeypot;
conduct at least one attack on the honeypot using a large language model;
ascertain an assessment of the at least one attack; and
configure the honeypot depending on the assessment of the at least one attack.

17. A non-transitory computer-readable medium on which are stored commands configuring a honeypot, the commands, when executed by a processor, causing the processor to perform the following steps:
implementing a honeypot;
conducting at least one attack on the honeypot using a large language model;
ascertaining an assessment of the at least one attack; and
configuring the honeypot depending on the assessment of the at least one attack.
